(19) United States
(12) Patent Application Publication
(10) Pub. No.: US 2006/0146211 A1
(43) Pub. Date: Jul. 6, 2006

(54) Non rectangular display device

(75) Inventors: Steven C Deane, Redhill (GB); Stephen J Battersby, Haywards Heath (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V. Groenewoudseweg 1, Eindhoven (NL)

(21) Appl. No.: 10/517,286

(22) PCT Filed: Jun. 4, 2003
(86) PCT No.: PCT/IB03/02499

§ 371 Date: Sep. 2, 2005

(30) Foreign Application Priority Data
Jun. 11, 2002 (GB) 0213320.5

(51) Int. Cl. G02F 1/136

(52) U.S. Cl. 349/42

(57) ABSTRACT

A display device has pixels 41 arranged in rows and columns 42,44 addressed by a grid of first and second addressing conductors 50,52. The addressing conductors 50,52 are not parallel with the pixel rows or pixel columns 42,44. This arrangement decouples the row and columns of pixels from the addressing conductors. This provides freedom in the positioning of the driver circuits, which are positioned at the ends of the first and second conductors, which in turn gives greater design freedom for the shape and position of the display in a product.

This invention relates to display devices, for example active matrix display devices.

Active matrix displays typically comprise an array of pixels arranged in rows and columns. Each row of pixels shares a row conductor which connects to the gates of the thin film transistors of the pixels in the row. Each column of pixels shares a column conductor, to which pixel drive signals are provided. The signal on the row conductor determines whether the transistor is turned on or off, and when the transistor is turned on, by a high voltage pulse on the row conductor, a signal from the column conductor is allowed to pass on to an area of liquid crystal material (or other capacitive display cell), thereby altering the light transmission characteristics of the material.

FIG. 1 shows a conventional pixel configuration for an active matrix liquid crystal display. The display is arranged as an array of pixels in rows and columns. Each row of pixels shares a common row conductor 10, and each column of pixels shares a common column conductor 12. Each pixel comprises a thin film transistor 14 and a liquid crystal cell 16 arranged in series between the column conductor 12 and a common electrode 18. The transistor 14 is switched on and off by a signal provided on the row conductor 10. The row conductor 10 is thus connected to the gate 14a of each transistor 14 of the associated row of pixels. Each pixel additionally may comprise a storage capacitor 20 which is connected at one end 22 to the next row electrode, to the preceding row electrode, or to a separate capacitor electrode. The capacitance of the pixel (capacitor 20 or self-capacitance) stores a drive voltage so that a signal is maintained across the liquid crystal cell 16 even after the transistor 14 has been turned off.

In order to drive the liquid crystal cell 16 to a desired voltage to obtain a required grey level, an appropriate signal is provided on the column conductor 12 in synchronism with a row address pulse on the row conductor 10. This row address pulse turns on the thin film transistor 14, thereby allowing the column conductor 12 to charge the liquid crystal cell 16 to the desired voltage, and also to charge the storage capacitor 20 to the same voltage. At the end of the row address pulse, the transistor 14 is turned off, and the storage capacitor 20 maintains a voltage across the cell 16 when other rows are being addressed. The storage capacitor 20 reduces the effect of liquid crystal leakage and reduces the percentage variation in the pixel capacitance caused by the voltage dependency of the liquid crystal cell capacitance.

The rows are addressed sequentially so that all rows are addressed in one frame period, and refreshed in subsequent frame periods.

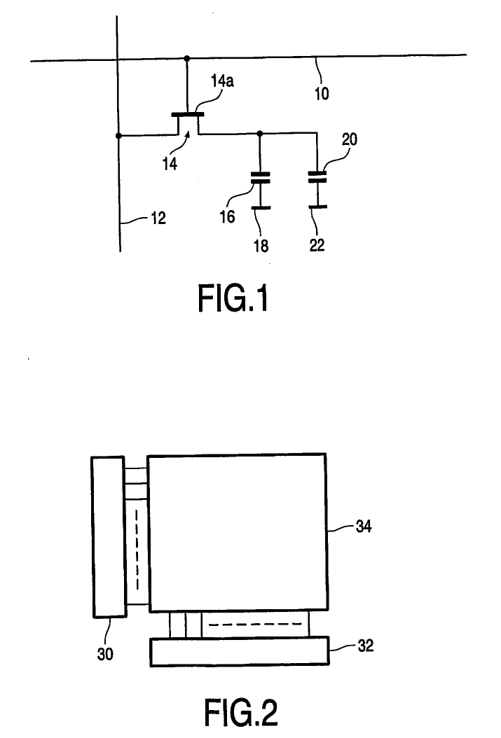

As shown in FIG. 2, the row address signals are provided by row driver circuitry 30, and the pixel drive signals are provided by column address circuitry 32, to the array 34 of display pixels.

The conventional layout provides a regular array of pixels of identical size and shape, and occupying the maximum area in the spaces within the row and column conductor grid. This is particularly desirable for transmissive displays because the pixel aperture must be as large as possible and the array must be regular to minimise visual impairments such as Moire fringes. With reflective displays (and some emissive technologies) it is possible for the pixels to overlie the row and column conductors so that the relative positioning of the pixel and the electrodes is not important, and can be different for different pixels.

Displays have conventionally been rectangular in shape, and this enables all pixels in the display to be addressed using a single row driver circuit and a single column address circuit, as shown in FIG. 2. However, designers now incorporate non-rectangular displays into product designs, and this requires modification to arrangement of the row and column driver circuits if the pixels are to be addressed by an orthogonal matrix of row and column conductors.

According to the invention, there is provided a display device comprising an array of pixels arranged in pixel rows and pixel columns and a grid of first addressing conductors and second addressing conductors, each individual pixel in the array being associated with an intersection of a respective pair of the first and second addressing conductors and thereby being uniquely addressable by the pair of addressing conductors, wherein the first and second addressing conductors are not parallel with the pixel rows or pixel columns.

This arrangement decouples the row and columns of pixels from the addressing conductors (which are in conventional displays termed row and column conductors). This provides freedom in the positioning of the driver circuits, which are positioned at the ends of the first and second conductors. This freedom enables space savings to be made to meet requirements of product designs, for example which do not give significant lateral space.

Preferably, the array of pixels comprises a regular array of identically-sized pixels. This maintains image quality.

The first and second addressing conductors can be straight, and the first conductors can be parallel to each other and the second addressing conductors can be parallel to each other. The intersections between the first and second conductors may or may not be perpendicular.

Either or both of the first and second addressing conductors may not all be parallel to each other. This enables the conductors to fan in our out, for example for a fan shaped display. They may also be curved.

Preferably, the display is a reflective or emissive display. In these displays, the pixel area can be positioned over the electrodes and independently of the specific electrode positions. The display may be a transflective display.

Examples of the invention will now be described in detail with reference to the accompanying drawings, in which:

FIG. 1 shows one example of a known pixel configuration for an active matrix liquid crystal display;

FIG. 2 shows a display device including row and column driver circuitry;

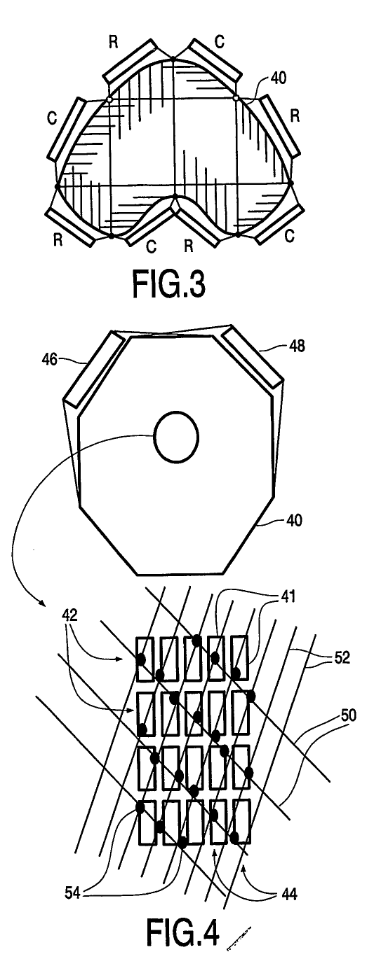

FIG. 3 shows how the row and column driver circuits can be modified to enable addressing of non-rectangular displays;

FIG. 4 shows a first example of display device of the invention;

FIG. 5 shows a second example of display device of the invention; and

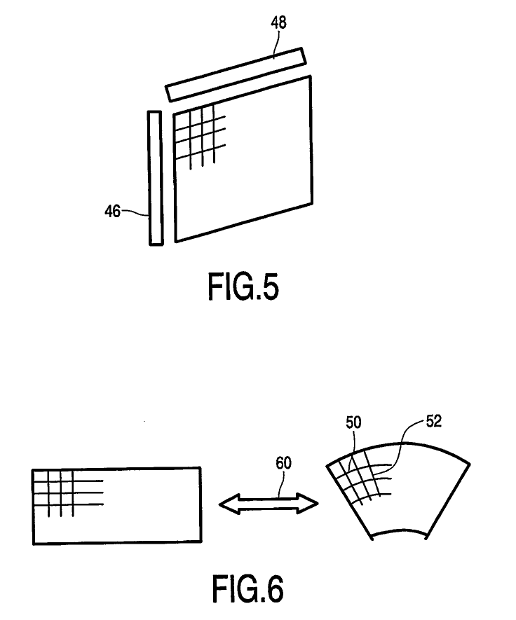

FIG. 6 shows a third example of display device of the invention.

FIG. 3 shows one possible way to enable a non-rectangular display to be addressed using an orthogonal array of row and column conductors. The device has an array of pixels having a non-rectangular outer shape 40. To ensure that each pixel within the array is coupled to row and column driver circuits, the row and column driver circuitry is divided into row driver circuit portions “R” and column driver circuit portions “C”. As shown in FIG. 3, each circuit portion connects to a region of the outer shape 40. The row driver circuit portions “R” and the column driver circuit portions “C” are arranged alternately around the periphery of the array of pixels. This alternating arrangement enables complicated display shapes to be addressed.

This approach clearly complicates the row and column driver circuitry. The invention provides modification to the row and column conductor grid in order to enable non-rectangular display shapes to be addressed whilst minimising the need to divide the row and column driver circuitry into sections as in FIG. 3.

FIG. 4 shows a first example of display device of the invention, which comprises an array 40 of pixels 41 arranged in orthogonal pixel rows 42 and pixel columns 44. The array 40 is arranged as an octagon, and the row and column driver circuits 46,48 are arranged in the top corners of the display. The term “row” and “column” are somewhat arbitrary in connection with the driver circuits, as the address conductors driven by the circuits are not aligned with the rows or columns of pixels, nor are they necessarily orthogonal. Instead, the address conductors may be considered as a first set 50 and a second set 52, which together define a grid. Each individual pixel 41 in the array is associated with an intersection 54 of a respective pair of the first and second addressing conductors 50,52 and is thereby uniquely addressable by the pair of addressing conductors. Each pixel may then comprise a pixel circuit such as that shown in FIG. 1.

This arrangement decouples the row and columns of pixels from the addressing conductors. This provides freedom in the positioning of the driver circuits. This freedom enables space savings to be made to meet requirements of product designs. For example, the design of FIG. 4 requires reduced lateral space on either side of the display, so that the display area may occupy more fully the available area, and is also better centered.

The array of pixels can remain as a regular array of identically-sized pixels as shown schematically in FIG. 4, so that image quality is not degraded.

One implication of the angled conductors 50,52 of FIG. 4 is that the intersection point 54 is not at the same position relative to the pixel area for each pixel. Instead, the pixel circuit design needs to take account of the position of each intersection. Of course, if the first and second address conductors 50,52 are at 45 degrees to the pixel row and column directions, and orthogonal to each other, then (for square pixels) the intersection point will be at the same location for each pixel. Indeed, there are many possible combinations of angles for the address conductors which provide a small finite number of different pixel connection positions. It is then possible for the pixel layout to be designed as a repeating pattern of super-pixels (for example a block of 3×3 Red Green and Blue pixels). The layout only then needs to be designed and simulated for a super-pixel block.

The invention is particularly suitable for a reflective or emissive display. In these displays, the pixel area is positioned over the electrodes, typically with connection of the pixel electrode to an underlying electrode through a via in an insulating layer. Thus, the via location and the shape of the underlying electrode can be different for different pixels to correspond to the desired address conductor arrangement.

In the example of FIG. 4, the first and second addressing conductors 50,52 are straight, and the first conductors are all parallel to each other and the second addressing conductors are also all parallel to each other. This provides the simplest pixel addressing scheme. As mentioned above, the intersections between the first and second conductors may or may not be perpendicular.

FIG. 5 shows a display in the shape of a parallelogram, in which non-orthogonal first and second address conductors enable individual “row” and “column” driver circuits 46,48 to be employed.

In another example, one (or both) set of addressing conductors may not be parallel to each other. FIG. 6 shows how a rectangular display can be converted into a fan beam shape by a conformal mapping process 60. The row conductors are mapped into curved first addressing conductors 50, and the column conductors are mapped into non-parallel but straight second addressing conductors 52. It is assumed that the pixel array remains regular in orthogonal rows and columns, again to prevent image impairment.

There may, however, be cases where the pixels are desired to have different resolutions or shapes in different parts of the display. For example, the conformal mapping operation 60 of FIG. 6 may also be applied to the pixel arrangement. The invention can also be applied in such situations.

This conformal mapping operation can be applied to any display and address conductor shape, for example that of FIG. 3 to arrive at an even less regular and less symmetric shape. The symmetry of the display shape of FIG. 3 helps reduce the number of divisions of the row and column address circuitry into different portions, and this invention enables further irregularity to be introduced without adding complexity to the row and column driver circuitry.

The invention can be applied to any pixel layout, although it is of particular benefit for active matrix displays in which each pixel includes switching circuitry controlled by the first and second addressing conductors. The pixel layout of FIG. 1 is only one example of many different pixel circuits which may be employed.

From reading the present disclosure, other variations and modifications will be apparent to persons skilled in the art. Such variations and modifications may involve equivalent and other features which are already known in the art, and which may be used instead of or in addition to features already described herein.

1. A display device comprising an array of pixels arranged in pixel rows and pixel columns and a grid of first addressing conductors and second addressing conductors, each individual pixel in the array being associated with an intersection of a respective pair of the first and second addressing conductors and thereby being uniquely addressable by the pair of addressing conductors, wherein the first and second addressing conductors are not parallel with the pixel rows or pixel columns.

2. A device as claimed in claim 1, wherein the array of pixels comprises a regular array of identically-sized pixels.

3. A device as claimed in claim 1, wherein the first and second addressing conductors are straight.

4. A device as claimed in claim 3, wherein the first addressing conductors are parallel to each other and the second addressing conductors are parallel to each other.

5. A device as claimed in claim 3, wherein either or both of the first and second addressing conductors are not all parallel to each other.

6. A device as claimed in claim 3, wherein the first and second addressing conductors are non-orthogonal.

7. A device as claimed in claim 1, wherein either or both of the first and second addressing conductors are curved.

8. A device as claimed in any preceding claim comprising a reflective or emissive display.

9. A device as claimed in claim 1 comprising an active matrix display device.
